(19) United States
(12) Patent Application Publication
(10) Pub. No.: US 2011/0133413 A1
(43) Pub. Date: Jun. 9, 2011

(54) PROPELLER SHAFT APPARATUS

(75) Inventors: Daisuke Kato, Haga-gun (JP); Tomoya Kondoh, Haga-gun (JP)

(73) Assignee: SHOWA CORPORATION, Gyoda-shi (JP)

(21) Appl. No.: 12/795,651

(22) Filed: Jun. 7, 2010

(30) Foreign Application Priority Data
Dec. 7, 2009 (JP) 2009-277996

(51) Int. Cl. F16J 15/32

(52) U.S. Cl. 277/565

(57) ABSTRACT

In a propeller shaft apparatus in which a propeller shaft is supported by a support mechanism via a bearing, and the bearing is sealed from an external environment by a dust seal attached to an inner periphery of the support mechanism and coming into sliding contact with an outer periphery of the propeller shaft, the dust seal includes at least first and second lips extending to both sides in an axial direction, an inner diameter of a leading end of one lip of the first and second lips is made smaller than an inner diameter of a leading end of the other lip, and a cross sectional area of the one lip is made larger than a cross sectional area of the other lip.

### BACKGROUND OF THE INVENTION

1. Field of the Invention

The present invention relates to a propeller shaft apparatus.

2. Description of the Related Art

In a propeller shaft apparatus, there is a structure in which a propeller shaft is supported by a support mechanism via a bearing, and the bearing is sealed from an external environment by a dust seal attached to an inner periphery of the support mechanism and coming into sliding contact with an outer periphery of the propeller shaft, as described in Japanese Unexamined Patent Publication No. 2008-273267 (patent document 1).

In the propeller shaft apparatus described in the patent document 1, the dust seal is provided with first and second lips which extend to both sides in an axial direction from an inner periphery of a core bar. Further, the first lip faces the bearing side, and the second lip faces the external environment opposite to the bearing. Grease filled in the bearing is prevented from flowing out by the first lip, and dust and muddy water in the external environment are prevented from getting in by the second lip, thereby retaining a fixed amount of grease between the first lip and the second lip.

With respect to the dust seal employed in the propeller shaft apparatus described in the patent document 1, a relationship between an angle of torsion at which the first and second lips are twisted by a friction force applied from the outer periphery of the propeller shaft, and a dimension and a shape of each of the lips is not addressed. Accordingly, an abnormal noise tends to be generated due to an unbalance between the angles of torsion of the first and second lips, and an accelerated wear may result.

Further, a fastening force which the first lip facing to the bearing side applies to the outer periphery of the propeller shaft is small. Accordingly, even if the grease retained between the first lip and the second lip is contaminated only slightly due to the influence of dust and muddy water in the external environment, the contaminant easily gets into the bearing side through the first lip so as to contaminate the grease in the bearing side, whereby a contamination resistance may be deteriorated.

### SUMMARY OF THE INVENTION

An object of the present invention is to reduce a generation of an abnormal noise due to an unbalance between angles of torsion of first and second lips in a propeller shaft apparatus.

Another object of the present invention is to improve a contamination resistance by keeping grease in a bearing side clean.

In a first aspect of the invention, there is provided a propeller shaft apparatus comprising a propeller shaft supported by a support mechanism via a bearing that is sealed from an external environment by a dust seal attached to an inner periphery of the support mechanism and coming into sliding contact with an outer periphery of the propeller shaft. The dust seal includes at least first and second lips extending to both sides in an axial direction. An inner diameter of a leading end of one lip of the first and second lips is made smaller than an inner diameter of a leading end of the other lip, and a cross sectional area of the one lip is made larger than a cross sectional area of the other lip.

In accordance with the present invention, the following operations and effects can be obtained.

(a) Since the inner diameter of the leading end of one lip of the first and second lips is made smaller than the inner diameter of the leading end of the other lip thereof, a fastening force which the one lip having the smaller inner diameter applies to the outer periphery of the propeller shaft increases. Accordingly, a friction force which the one lip having the smaller inner diameter is applied from the outer periphery of the propeller shaft is increased, and a torsion moment acting on the one lip due to the friction force is increased. On the other hand, a torsion moment acting on the other lip of the larger inner diameter is small.

In this case, since the one lip having the smaller inner diameter has a large cross sectional area and has a high rigidity, the angle of torsion is suppressed due to the high rigidity even if the torsion moment is large. On the other hand, since the other lip having the larger inner diameter has a small cross sectional area and has a low rigidity, the angle of torsion is not suppressed even if the torsion moment is small. As a result, it is possible to make the angles of torsion of the first and second lips approximately equal so as to balance, it is possible to reduce the generation of the abnormal noise due to the unbalance between the angles of torsion of the first and second lips, and it is possible to prevent an accelerated wear.

In a second aspect of the invention, there is provided the propeller shaft apparatus according to the first aspect, wherein the one lip is arranged so as to face to the bearing side.

In accordance with the present invention, the following operations and effects can be obtained.

(b) The one lip having the smaller inner diameter and having the larger fastening force faces to the bearing side. Accordingly, even if the grease retained between the one lip and the other lip is affected by dust and muddy water in the external environment via the other lip and contaminated, the contaminant does not easily get into the bearing side through the one lip. It is possible to keep the grease in the bearing side clean without being contaminated so as to improve the contamination resistance.

In a third aspect of the invention, there is provided the propeller shaft apparatus according to the first aspect, wherein the one lip is arranged so as to face to an external environment opposite to the bearing.

In accordance with the present invention, the following operations and effects can be obtained.

(c) The one lip having the smaller inner diameter and having the larger fastening force faces the external environment. Accordingly, the grease retained between the one lip and the other lip is not affected by dust and muddy water in the external environment and is hard to contaminate due to the presence of the one lip. Therefore, even if the grease retained between the one lip and the other lip gets into the bearing side through the other lip, it is possible to keep the grease in the bearing side clean without being contaminated so as to improve the contamination resistance.

In a fourth aspect of the invention, there is provided the propeller shaft apparatus according to the third aspect, wherein the other lip is arranged so as to face to the bearing side, and the leading end portion of the other lip is folded back toward an opposite side to the bearing.

In accordance with the present invention, the following operations and effects can be obtained.

(d) The leading end portion of the other lip facing the bearing side in the above (c) is folded back toward the opposite side to the bearing. Accordingly, the fold-back portion of the leading end of the other lip securely prevents the grease retained between the one lip and the other lip from getting into the bearing side through the other lip. It is possible to keep the grease in the bearing side clean without being contaminated so as to reliably improve the contamination resistance.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a partial cross sectional plan view showing a propeller shaft apparatus according to an embodiment 1;

FIG. 2 is an enlarged view of a main part of FIG. 1;

FIG. 3 is a cross sectional view showing a dust seal;

FIG. 4 is a partial cross sectional plan view showing a propeller shaft according to an embodiment 2;

FIG. 5 is an enlarged view of a main part of FIG. 4; and

FIG. 6 is a cross sectional view showing a dust seal.

### DESCRIPTION OF THE PREFERRED EMBODIMENTS

### Embodiment 1

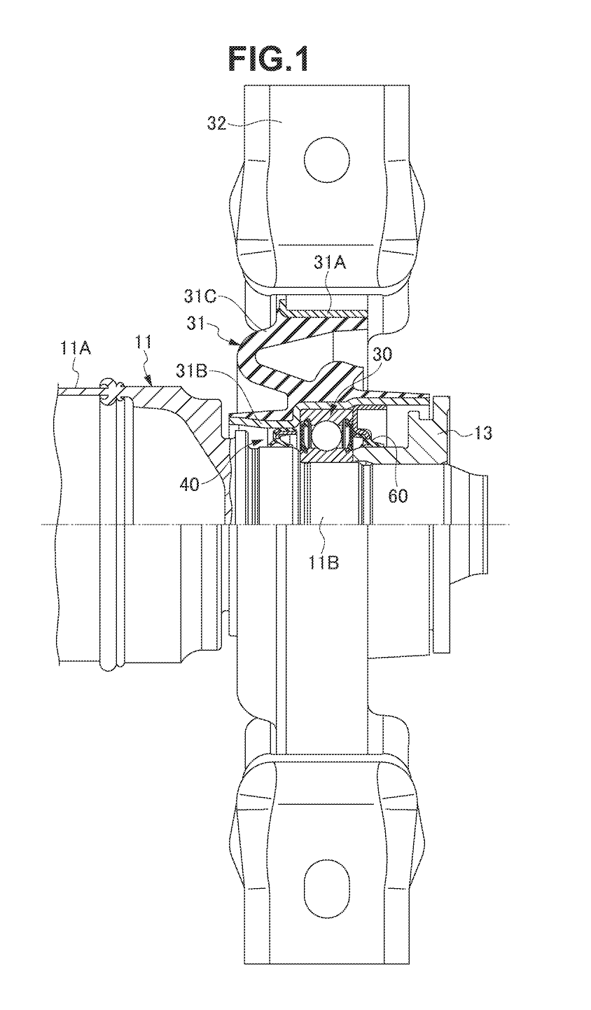

### FIGS. 1 to 3

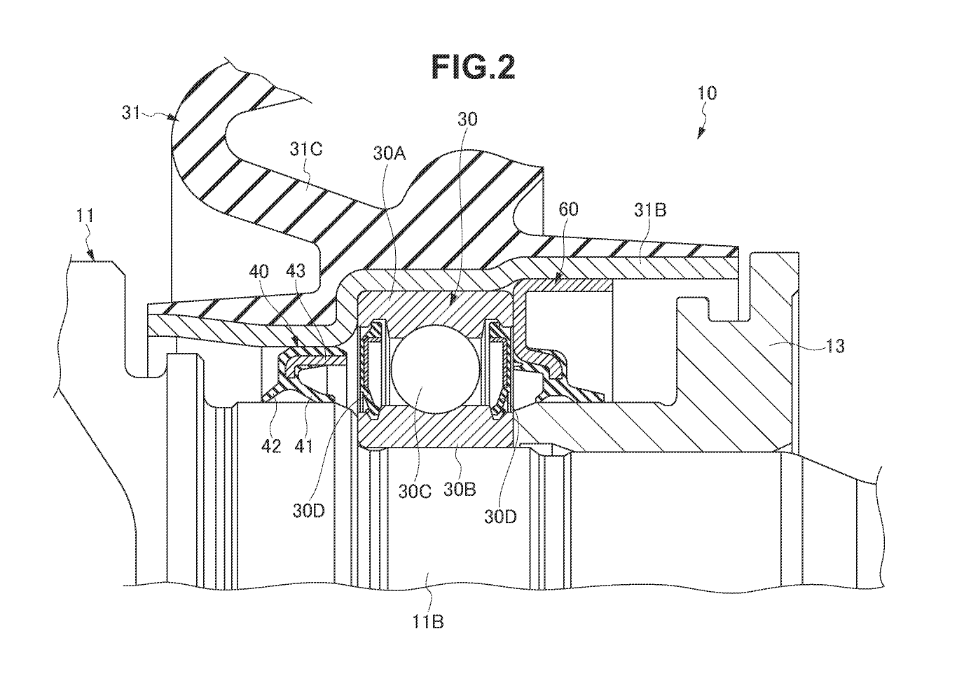

A propeller shaft apparatus 10 for a motor vehicle is a coupled body of a plurality of propeller shafts 11, 12 and the like, such as three pieces of propeller shafts, and is structured, for example, such that an engine side propeller shaft 11 and a rear wheel side propeller shaft 12 (not shown) are coupled by a constant velocity joint 20 (not shown), and the propeller shaft 11 is supported by a center bearing 30 so as to be rotatable with respect to a vehicle body, in a part thereof, as shown in FIGS. 1 and 2.

In this case, the propeller shaft 11 is structured such that a stub shaft 11B is welded to one end of a hollow pipe 11A, the center bearing 30 is inserted and attached to a small-diameter intermediate portion of the stub shaft 11B, a stopper piece 13 is press-fit to the stub shaft 11B, and the center bearing 30 is pressed and fixed between a large-diameter step surface of the stub shaft 11B and an end surface of the stopper piece 13. The propeller shaft 12 is structured such that a tubular outer 12B (not shown) is welded to one end of a hollow pipe 12A (not shown). Further, the stub shaft 11B of the propeller shaft 11 and the tubular outer 12B of the propeller shaft 12 are coupled by the constant velocity joint 20.

Further, in the propeller shaft apparatus 10, as shown in FIG. 2, the center bearing 30 to be inserted and attached to the stub shaft 11B of the propeller shaft 11 is fitted to an annular support mechanism 31 in advance, and the annular support mechanism 31 is supported by a support bracket 32 fixed to a vehicle body side. The center bearing 30 includes an outer race 30A, an inner race 30B, a ball 30C and a ball shield 30D. The annular support mechanism 31 is structured such that an outer ring 31A and an inner ring 31B are bonded via a rubber-like elastic member 31C, the outer ring 31A is fitted and fixed to the support bracket 32, and outer race 30A of the center bearing 30 is fitted and fixed to the inner ring 31B. The inner ring 31B extends to both sides of the center bearing 30, dust seals 40 and 60 are attached to inner peripheries of both side extending portions of the inner ring 31B, and the dust seals 40 and 60 come into sliding contact with an outer periphery of the stub shaft 11B of the propeller shaft 11 and the stopper piece 13 so as to seal both sides of the center bearing 30 from the external environment. The propeller shaft 11 is structured such that the inner race 30B of the center bearing 30 fitted to the inner ring 31B of the annular support mechanism 31 is inserted and attached to the small-diameter intermediate portion of the stub shaft 11B, and the stopper piece 13 is press-fit to the stub shaft 11B in this state. As a result, the center bearing 30 is pressed and fixed between the large-diameter stop surface of the stub shaft 11B and the end surface of the stopper piece 13.

Accordingly, in the propeller shaft apparatus 10, the dust seal 40 is structured as follows.

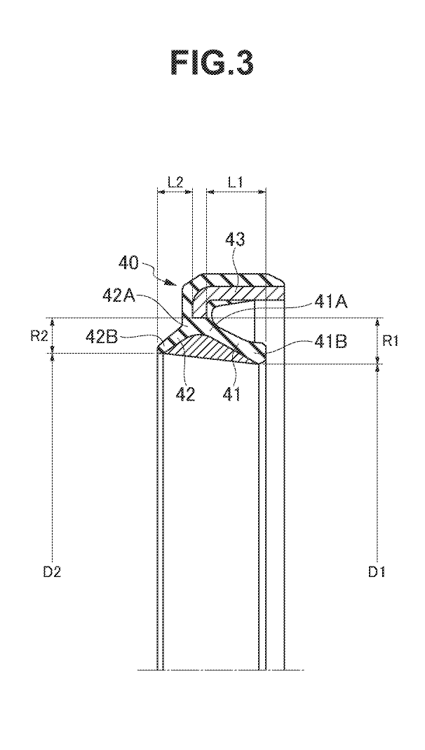

The dust seal 40 is an annularly formed body in which a rubber body forming first and second lips 41 and 42 is formed by bake-molding around a core bar 43, as shown in FIG. 3. The dust seal 40 is arranged in such a manner that the first lip 41 and the second lip 42 extend to both sides in an axial direction from an inner peripheral end of the core bar 43, the first lip 41 faces the center bearing 30 side, and the second lip 42 faces the external environment side opposite to the center bearing 30. The first lip 41 has a leading end portion 41B having a diameter gradually decreasing from a base end portion 41A attached by bake-molding to an inner peripheral end of the core bar 43 toward the center bearing 30 side and coming into sliding contact with the outer periphery of the stub shaft 11B of the propeller shaft 11. The second lip 42 has a leading end portion 42B having a diameter gradually decreasing from a base end portion 42A attached by bake-molding to the inner peripheral end of the core bar 43 toward the external field side and coming into sliding contact with the outer periphery of the stub shaft 11B of the propeller shaft 11.

In the dust seal 40 in a free state shown in FIG. 3, an inner diameter D1 of the leading end portion 41B of the first lip 41 that is one of the first and second lips 41 and 42 is smaller than an inner diameter D2 of the leading end portion 42B of the second lip 42 that is the other of the lips 41 and 42, and a cross sectional area of the first lip 41 (a cross sectional area from the base end portion 41A to the leading end portion 41B on a radius of the dust seal 40) is larger than a cross sectional area of the second lip 42 (a cross sectional area from the base end portion 42A to the leading end portion 42B on the radius of the dust seal 40).

In this case, relationships of L1>L2 and R1>R2 are satisfied, where L1 and R1 are a length in an axial direction between the base end portion 41A and the leading end portion 41B and a length in a radial direction, respectively, of the first lip 41, and L2 and R2 are a length in an axial direction between the base end portion 42A and the leading end portion 42B and a length in a radial direction, respectively, of the second lip 42.

The dust seal 40 prevents the grease filled in the center bearing 30 from flowing out by means of the first lip 41, prevents the dust and the muddy water in the external environment from getting thereinto by means of the second lip 42, and retains a fixed amount of grease between the first lip 41 and the second lip 42 (in a hatched region shown in FIG. 3).

According to the present embodiment, the following effects can be obtained.

(a) Since the inner diameter of the leading end of the first lip 41 is made smaller than the inner diameter of the leading end of the second lip 42 in the first and second lips 41 and 42, a fastening force which the first lip 41 having the smaller inner diameter applies to the outer periphery of the stub shaft 11B of the propeller shaft 11 increases. Accordingly, a friction force (a rotational slide resisting force) which the first lip 41 having the smaller inner diameter is applied from the outer periphery of the stub shaft 11B of the propeller shaft 11 is increased, and a torsion moment acting on the first lip 41 caused by the friction force is increased. The moment acts largely on the base end portion 41A. On the other hand, the friction force of the second lip 42 having the larger inner diameter is smaller by an amount corresponding to the larger inner diameter of the lip and an acting torsion moment is also small.

In this case, since the first lip 41 having the smaller inner diameter has a large cross sectional area and has a high rigidity, an angle of torsion (an amount of deformation) is suppressed due to the high rigidity even if the torsion moment is large. On the other hand, since the second lip 42 having the larger inner diameter has a small cross sectional area and has a low rigidity, an angle of torsion becomes relatively larger even if the torsion moment is small. As a result, it is possible to make the angles of torsion between the base end portions 41A and 42A of the first and second lips 41 and 42 approximately equal so as to balance, it is possible to reduce the generation of the abnormal noise caused by a twisting deformation between the base end portions 41A and 42A of the first and second lips 41 and 42, and it is possible to prevent an accelerated wear of the lip.

(b) The first lip 41 having the smaller inner diameter and having the larger fastening force faces to the center bearing 30 side. Accordingly, even if the grease retained between the first lip 41 and the second lip 42 is affected by dust and muddy water in the external environment via the second lip 42 and contaminated, the contaminant does not easily get into the center bearing 30 side through the first lip 41. It is possible to keep the grease in the center bearing 30 side clean without being contaminated so as to improve a contamination resistance. Further, since it is possible to make the friction force small by arranging the second lip 42 having the larger inner diameter so as to face to the external environment side opposite to the center bearing 30, it is possible to prevent a stick slip.

### Embodiment 2

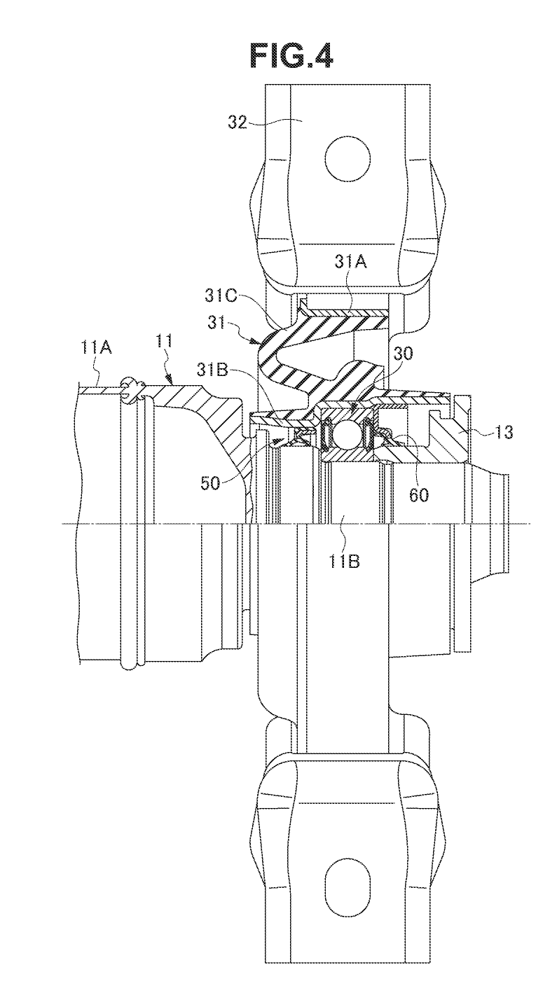

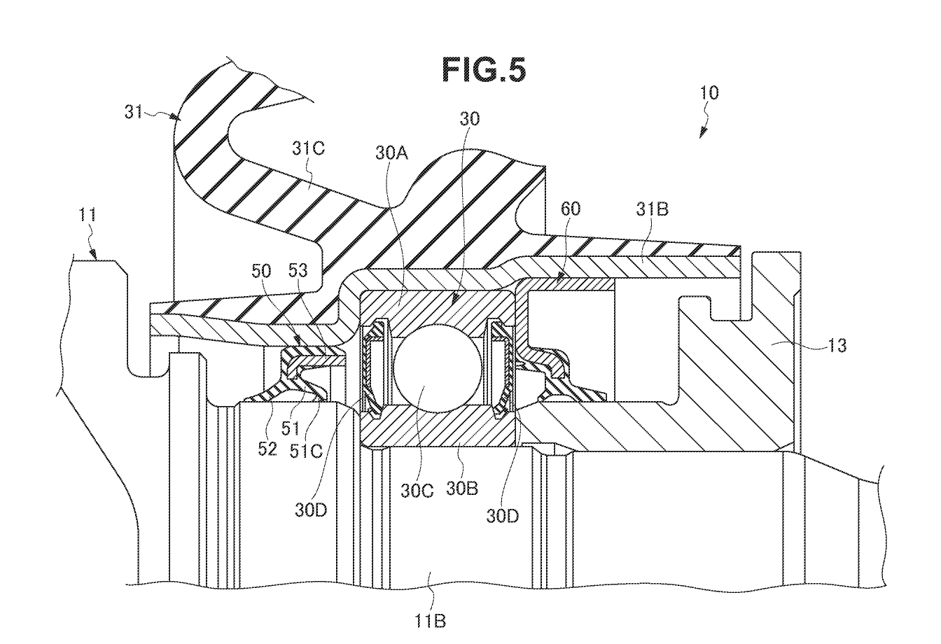

### FIGS. 4 to 6

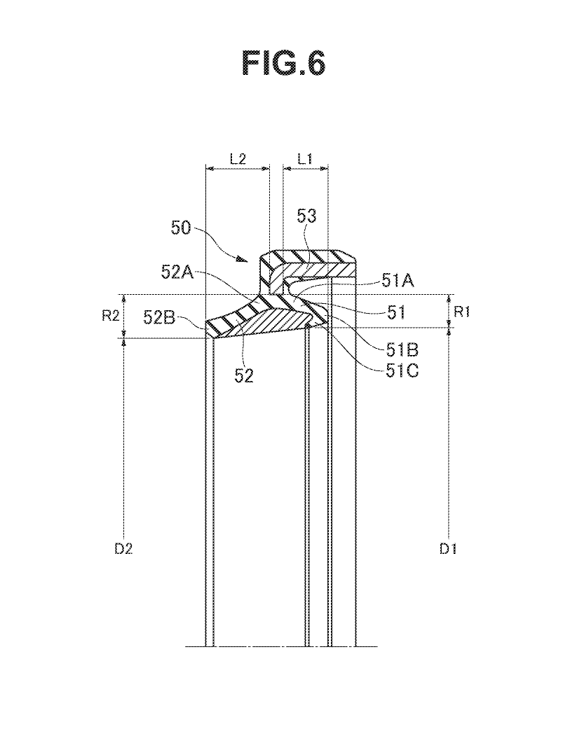

An embodiment 2 differs from the embodiment 1 in that a dust seal 50 is employed in place of the dust seal 40, as shown in FIGS. 4 to 6. The dust seal 50 is an annularly formed body in which a rubber body forming first and second lips 51 and 52 is formed by bake-molding around a core bar 53, as shown in FIG. 6. The dust seal 50 is arranged in such a manner that the first lip 51 and the second lip 52 extend to both sides in an axial direction from an inner peripheral end of the core bar 53, the first lip 51 faces the center bearing 30 side, and the second lip 52 faces the external environment side opposite to the center bearing 30. The first lip 51 has a leading end portion 51B having a diameter gradually decreasing from a base end portion 51A attached by bake-molding to an inner peripheral end of the core bar 53 toward the center bearing 30 side and coming into sliding contact with the outer periphery of the stub shaft 11B of the propeller shaft 11. The second lip 52 has a leading end portion 52B having a diameter gradually decreasing from a base end portion 52A attached by bake-molding to the inner peripheral end of the core bar 53 toward the external environment side and coming into sliding contact with the outer periphery of the stub shaft 11B of the propeller shaft 11.

In the dust seal 50 in a free state shown in FIG. 6, an inner diameter D2 of the leading end portion 52B of the second lip 52 that is one of the first and second lips 51 and 52 is smaller than an inner diameter D1 of the leading end portion 51B of the first lip 51 that is the other of the lips 51 and 52, and a cross sectional area of the second lip 52 (a cross sectional area from the base end portion 52A to the leading end portion 52B on a radius of the dust seal 50) is larger than a cross sectional area of the first lip 51 (a cross sectional area from the base end portion 51A to the leading end portion 51B on the radius of the dust seal 50).

In this case, relationships of L2>L1 and R2>R1 are satisfied, where L2 and R2 are a length in an axial direction between the base end portion 52A and the leading end portion 52B and a length in a radial direction, respectively, of the second lip 52, and L1 and R1 are a length in an axial direction between the base end portion 51A and the leading end portion 51B and a length in a radial direction, respectively, of the first lip 51.

The dust seal 50 has a fold-back portion 51C formed in a manner that the leading end portion 51B of the first lip 51 is folded back toward an opposite side to the center bearing 30 to form a U-shape or a V-shape.

The dust seal 50 prevents the grease filled in the center bearing 30 from flowing out by means of the first lip 51, prevents dust and muddy water in the external environment from getting there into by means of the second lip 52, and retains a fixed amount of grease between the first lip 51 and the second lip 52 (in a hatched region shown in FIG. 6).

According to the present embodiment, the following effects can be obtained.

(a) Since the inner diameter of the leading end of the second lip 52 is made smaller than the inner diameter of the leading end of the first lip 51 in the first and second lips 51 and 52, a fastening force which the second lip 52 having the smaller inner diameter applies to the outer periphery of the stub shaft 11B of the propeller shaft 11 increases. Accordingly, a friction force which the second lip 52 having the smaller inner diameter is applied from the outer periphery of the stub shaft 11B of the propeller shaft 11 is increased, and a torsion moment acting on the second lip 52 caused by the friction force is increased. On the other hand, a torsion moment acting on the first lip 51 having the larger inner diameter is small.

In this case, since the second lip 52 having the smaller inner diameter has a large cross sectional area and has a high rigidity, an angle of torsion is suppressed due to the high rigidity even if the torsion moment is large. On the other hand, since the first lip 51 having the larger inner diameter has a small cross sectional area and has a low rigidity, an angle of torsion (an amount of deformation) becomes relatively larger even if the torsion moment is small. As a result, it is possible to make the angles of torsion between the first and second lips 51 and 52 approximately equal so as to balance, it is possible to reduce the generation of the abnormal noise caused by a twisting deformation between the base end portions 51A and 52A of the first and second lips 51 and 52, and it is possible to prevent an accelerated wear of the lip.

(b) The second lip 52 having the smaller inner diameter and having the larger fastening force faces to the external environment. Accordingly, the grease retained between the second lip 52 and the first lip 51 is not affected by dust and muddy water in the external environment and is hard to contaminat due to the presence of the second lip 52. Therefore, even if the grease retained between the second lip 52 and the first lip 51 gets into the center bearing 30 side through the first lip 51, it is possible to keep the grease in the center bearing 30 side clean from being contaminated so as to improve the contamination resistance.

(c) The leading end portion 51B of the first lip 51 facing to the center bearing 30 side in the above (b) is folded back toward the opposite side to the center bearing 30. Accordingly, the fold-back portion 51C of the leading end of the first lip 51 securely prevents the grease retained between the second lip 52 and the first lip 51 from getting into the center bearing 30 side through the first lip 51. It is possible to keep the grease in the center bearing 30 side clean from being contaminated so as to reliably improve the contamination resistance.

The present invention provides the propeller shaft apparatus in which the propeller shaft is supported by the support mechanism via the bearing, and the bearing is sealed from the external environment by the dust seal attached to the inner periphery of the support mechanism and coming into sliding contact with the outer periphery of the propeller shaft, wherein the dust seal is provided with the first and second lips extending to both sides in the axial direction, the inner diameter of the leading end of the one lip of the first and second lips is made smaller than the inner diameter of the leading end of the other lip, and the cross sectional area of the one lip is made larger than the cross sectional area of the other lip. Accordingly, in the propeller shaft apparatus, it is possible to reduce the generation of the abnormal noise caused by the unbalance of the angles of torsion between the first and second lips. Further, it is possible to keep the grease in the bearing side clean so as to improve the contamination resistance.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A propeller shaft apparatus, comprising:
a propeller shaft supported by a support mechanism via a bearing that is sealed from an external environment by a dust seal attached to an inner periphery of the support mechanism and coming into sliding contact with an outer periphery of the propeller shaft, wherein
the dust seal includes at least first and second lips extending to both sides in an axial direction, and
an inner diameter of a leading end of one lip of the first and second lips is made smaller than an inner diameter of a leading end of the other lip, and a cross sectional area of the one lip is made larger than a cross sectional area of the other lip.

2. The propeller shaft apparatus according to claim 1, wherein the one lip is arranged so as to face toward the bearing side.

3. The propeller shaft apparatus according to claim 1, wherein the one lip is arranged so as to face toward an external environment opposite to the bearing.

4. The propeller shaft apparatus according to claim 3, wherein the other lip is arranged so as to face toward the bearing side, and the leading end portion of the other lip is folded back toward an opposite side to the bearing.

5. The propeller shaft apparatus according to claim 4, wherein the leading end portion of the other lip is folded back so as to form a U-shape toward an opposite side to a center bearing.

6. The propeller shaft apparatus according to claim 4, wherein the leading end portion of the other lip is folded back so as to form a V-shape toward an opposite side to a center bearing.

7. The propeller shaft apparatus according to claim 1, wherein a fixed amount of grease is retained between the first lip and the second lip of the dust seal coming into sliding contact with the outer periphery of the propeller shaft.

8. The propeller shaft apparatus according to claim 2, wherein a fixed amount of grease is retained between the first lip and the second lip of the dust seal coming into sliding contact with the outer periphery of the propeller shaft.

9. The propeller shaft apparatus according to claim 3, wherein a fixed amount of grease is retained between the first lip and the second lip of the dust seal coming into sliding contact with the outer periphery of the propeller shaft.

10. The propeller shaft apparatus according to claim 4, wherein a fixed amount of grease is retained between the first lip and the second lip of the dust seal coming into sliding contact with the outer periphery of the propeller shaft.

11. The propeller shaft apparatus according to claim 5, wherein a fixed amount of grease is retained between the first lip and the second lip of the dust seal coming into sliding contact with the outer periphery of the propeller shaft.

12. The propeller shaft apparatus according to claim 6, wherein a fixed amount of grease is retained between the first lip and the second lip of the dust seal coming into sliding contact with the outer periphery of the propeller shaft.

13. The propeller shaft apparatus according to claim 1, wherein a rubber body forming the first lip and the second lip is an annularly formed body which is formed by bake-molding around a core bar.

14. The propeller shaft apparatus according to claim 2, wherein a rubber body forming the first lip and the second lip is an annularly formed body which is formed by bake-molding around a core bar.

15. The propeller shaft apparatus according to claim 3, wherein a rubber body forming the first lip and the second lip is an annularly formed body which is formed by bake-molding around a core bar.

16. The propeller shaft apparatus according to claim 4, wherein a rubber body forming the first lip and the second lip is an annularly formed body which is formed by bake-molding around a core bar.

17. The propeller shaft apparatus according to claim 5, wherein a rubber body forming the first lip and the second lip is an annularly formed body which is formed by bake-molding around a core bar.

18. The propeller shaft apparatus according to claim 6, wherein a rubber body forming the first lip and the second lip is an annularly formed body which is formed by bake-molding around a core bar.

19. The propeller shaft apparatus according to claim 7, wherein a rubber body forming the first lip and the second lip is an annularly formed body which is formed by bake-molding around a core bar.

20. The propeller shaft apparatus according to claim 8, wherein a rubber body forming the first lip and the second lip is an annularly formed body which is formed by bake-molding around a core bar.
